(19) United States
(12) Patent Application Publication
(10) Pub. No.: US 2010/0212600 A1
(43) Pub. Date: Aug. 26, 2010

(54) USE OF A NOISE-GENERATING DEVICE FOR THE TRAINING OF DOGS AND DEVICE THEREFOR

(76) Inventor: Karl Heinz Knies, Reichelsheim (DE)

Correspondence Address: CROWELL & MORING LLP;INTELLECTUAL PROPERTY GROUP, P.O. BOX 14300, WASHINGTON, DC, 20044-4300, US

(21) Appl. No.: 12/663,252

(22) PCT Filed: Jun. 6, 2008
(86) PCT No.: PCT/DE2008/000935

§ 371 Date: Dec. 4, 2009

(30) Foreign Application Priority Data
Jun. 6, 2007 (DE) 10 2007 026 818.3

(51) Int. Cl. A01K 15/02

(52) U.S. Cl. 119/719

(57) ABSTRACT

A method and device for training a dog is disclosed. In an embodiment of the method, a device is worn on the side the trainer's body at a height of the dog's head. A button on the device is activated by the dog's muzzle to generate a noise. A reward is given to the dog by the trainer following the activation of the button. In an embodiment of the device, the device includes a housing with a noise-generating element and a button for operation of the noise-generating element. An attachment device is provided on a back side of the housing, where the attachment device is coupleable to the trainer. An activation surface for the button is provided on a front side of the housing and a surface normal of the activation surface, when worn on the trainer's body, is inclined obliquely downward and laterally away from the trainer's body.

### BACKGROUND AND SUMMARY OF THE INVENTION

This application claims the priority of International Application No. PCT/DE2008/000935, filed Jun. 6, 2008, and German Patent Document No. 10 2007 026 818.3, filed Jun. 6, 2007, the disclosures of which are expressly incorporated by reference herein.

The invention relates to the use of a noise-generating device for training dogs.

A dog should be required to heel, i.e., the dog should run directly next to the trainer without a leash, with his head always next to the trainer's hip. The dog should neither run ahead nor lag behind the trainer. At the same time, his head should be pointed obliquely upward toward the trainer, to be able to receive commands from him, if necessary. This behavior is tested in various dog tests and is the required for passing these tests.

It is known in general that animals may be trained with sounds; for example, a deterrent sound may be created by shaking a can, e.g., to stop a certain undesirable behavior by a dog. In seeking to avoid this sound, the animal will therefore stop the behavior. It is also known that sound may be used to promote certain desired behaviors, i.e., for positive reinforcement.

The invention is thus based on the object of using a noise-generating device to induce the desired running behavior of the dog as described above.

To achieve this object, the invention provides that the device should be worn on the trainer's body at the height of the dog's head, e.g., in the area of the trainer's hip in the case of large dogs or on the trainer's thigh in the case of small dogs, and that the device has a button to be activated by the dog's muzzle, such that a sound is generated when the button is activated by the dog's muzzle and then the dog receives a reward from the trainer, at least in the initial phase of training.

The training is based on so-called operant conditioning, in which a desired behavior is reinforced through rewards and is thereby trained.

The reward may be granted after the button has been activated once only after repeated activation of the button. This achieves the result that after a certain time, activation of the button by the dog and the generation of the noise thereby induced are interpreted as the reward by the dog.

After some training, the dog can and will reward himself by activating the button without having to be rewarded for it by the trainer. The desired leash-free running behavior will therefore be obtained as long as the noise-producing device is worn on the trainer's body in the aforementioned positions.

The active role of the animal in operant conditioning differentiates it from traditional conditioning in which, by frequent repetition in defined situations, an externally preselected neutral signal is capable of triggering a reflex that is already present.

In the aforementioned manner of wearing the device, the dog will thus attempt to repeatedly operate the button with his muzzle to obtain the reward. To remain with his muzzle close to the button, the dog must assume the desired running position as described above.

Since it should be a sound that promotes a certain behavior, according to the invention, it is a buzzing sound, which is not unpleasant to the dog.

The reward may be, for example, a chewable reward in the form of a “treat.” However, it may also be a toy, e.g., a ball, or a rope toy.

How the device is worn will depend naturally on the size of the dog. In other words, the device is worn on the trainer's body at a height so that the respective dog to be trained can reach it with his muzzle when his head is extended laterally upward.

The invention also relates to a noise-generating device that can be used for the training described above. To this extent, the use of the device defined in greater detail below is also part of the inventive use.

Such a device is characterized in that it has a housing with a noise-generating element and a button for operating the element, with means being provided on the back of the housing for attaching the housing to the trainer's body and an activation surface for the button being provided on the front side of the housing, the surface normal, when worn on the trainer's body, being directed obliquely downward and laterally away from the trainer's body.

Due to this alignment of the activation surface in the direction of the dog, this makes it easy for the dog to hit the activation surface with his muzzle and thus trigger the sound (the buzzing sound).

Since the dog should hold his head obliquely upward and therefore the movement of the muzzle will be in this direction, the button can be operated by the dog most easily when the surface normal lies in the direction of movement of the muzzle.

The activation surface may also be reached by the dog even if the dog is running slightly ahead of the trainer or falling slightly behind, so it is designed with a slight curve in a horizontal sectional plane (horizontal with respect to the position of the device when worn on the body). In other words, the surface normal regions of the activation surface in the curve are still directed downward but are pointed slightly forward or to the rear relative to the trainer's body. The activation surface then forms approximately a truncated conical segment with an axis running horizontally.

The button may be embodied in two ways. First, the housing may consist of a base body and a flap attached to it with a hinge, such that the means for attachment to the trainer's body are arranged on the back side of the base body, and the activation surface is arranged on the front side of the flap. When the dog touches the activation surface with his muzzle, the flap is moved toward the base body against the force of a spring, thereby closing a circuit, which results in a sound being triggered, because there is an electric contact on both the base body and the flap.

The sound may also be created by the fact that two contact surfaces formed on the facing surfaces of the base body and flap come in contact with one another. These thus form a noise-generating element. The contact surfaces may be the two contacts which close a circuit, as described above. The sound of the impact of the contacts may also be used as a signal for the trainer to dispense a reward to the dog. The impact sound alone instead of an electronically triggered buzzing sound may be used if the dog has become accustomed to the device, and a weak impact sound is sufficient to encourage the dog to operate the button.

The noise-generating element is preferably arranged in the base body. To amplify the sound, a resonance chamber is provided above the element in the back side of the flap facing the base body, such that the noise-generating element may protrude into the resonance chamber.

Essentially, however, a uniform housing may be utilized, in which case the button is embodied as a proximity sensor situated behind the activation surface. The dog therefore need only approach the activation surface with his muzzle in order for the proximity sensor to respond.

To train the dog to the required movement, an edible paste may initially be applied to the activation surface. In order for this paste to stick to the activation surface, recesses, e.g., in the form of cylindrical blind holes arranged side by side and/or elevations in the form of webs arranged side by side, are provided in the activation surface.

The invention is explained in greater detail below on the basis of two exemplary embodiments.

### BRIEF DESCRIPTION OF THE DRAWINGS

FIGS. 1a and 1b show perspective diagrams of the device in a first embodiment,

FIGS. 2a, b, c show various views of the device according to FIG. 1,

FIGS. 3a, b show cross sections through this device along lines A-A and/or B-B in FIG. 2a, and

FIGS. 4a, b, c show perspective views of the device in a second embodiment.

### DETAILED DESCRIPTION OF THE DRAWINGS

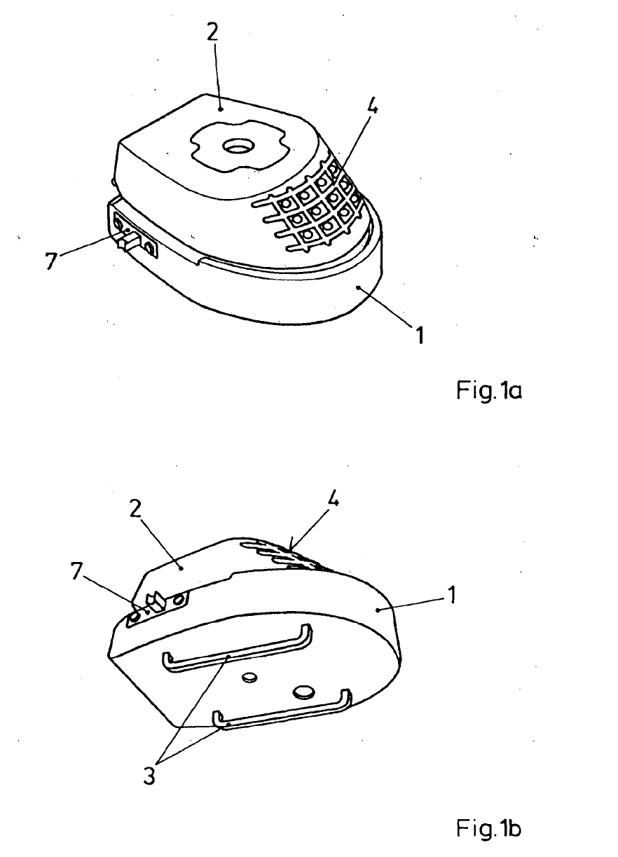

As can be deduced from the perspective diagrams in FIGS 1a and 1b, a device consists of a base body 1 and a flap 2, which strikes against a joint on the base body 1. Two straps 3, by means of which a belt can be tightened, are provided on the back side of the base body 1, so the trainer can wear the device on his hip. To be able to wear the device on the thigh, an elastic belt is tightened by the straps 3, thus spanning the thigh. The straps 3 thus form the means by which the device is to be attached to the trainer's body.

The front side of the flap 2 has an activation surface 4, which runs obliquely, corresponding approximately to a 180° segment of a truncated cone.

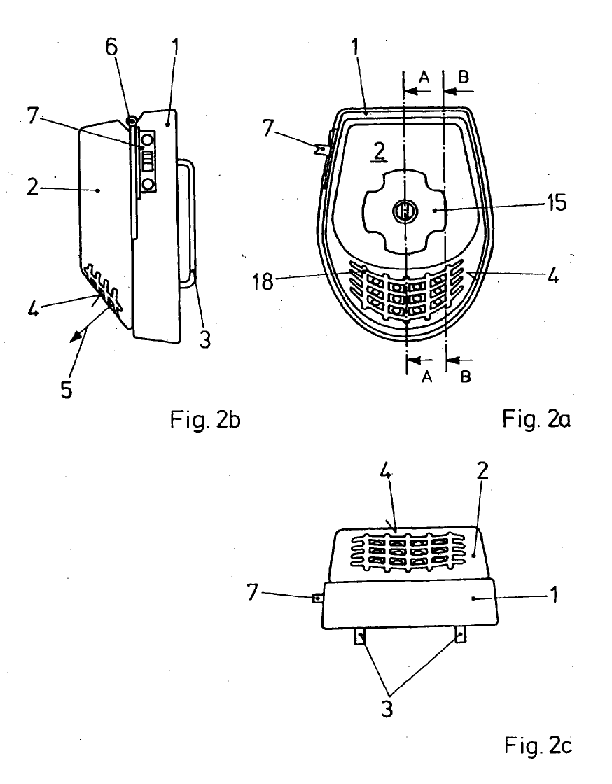

FIG. 2b shows a side view of the device in a vertical orientation, as it is worn on the trainer's body. The activation surface 4 points essentially downward, while the base area of the base body 1, to which the straps 3 are attached, points to the trainer's body. The activation surface 4 is situated in the lower area of the flap 2, with the surface normal 5 (in the central region of the activation surface 4) being situated in a vertical plane, which is perpendicular to the base body 1 and forms the plane of the drawing in the diagram in FIG. 2b. In the edge regions of the activation surface 4, the surface normals (not shown here) are directed slightly forward or slightly to the rear because of the truncated conical shape of the activation surface 4, i.e., they protrude into or out of the plane of the drawing.

A hinge 6 is provided between the base body 1 and the flap 2 on the top edge of the base body 1 and flap 2 at a distance from the activation surface 4, so that the flap 2 can be pivoted with respect to the base body 1.

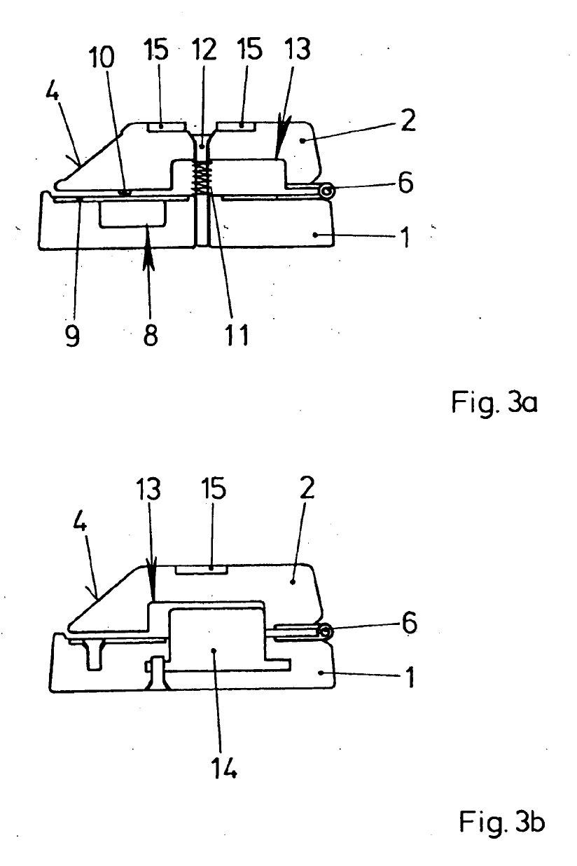

FIG. 2a shows a top view of the front side of the flap 2, and FIG. 2c shows a front view of the activation surface 4. In FIG. 2a one can see in particular that the base areas of the base body 1 and the flap 2 correspond, so there is a fluid transition between them. FIG. 2a also serves to illustrate two sectional planes A-A and B-B. Sections along these sectional planes are shown in FIGS. 3a and 3b.

FIG. 2c shows that the base body 1 and the flap 2 are the same height.

All three FIGS. 2a, 2b, 2c show a switch 7, with which the device is turned on and off.

The internal structure of the device is apparent from the two sectional diagrams of FIGS. 3a and 3b. In the base body 1 beneath the activation surface 4 there is a battery compartment 8, which is accessible from the top side of the base body and which is closed by a metallic cover, forming a first electric contact 9. On the bottom side of the flap 2, there is a second electric contact 10 above the battery compartment 8. In the central region of the device between the hinge 6 and the activation surface 4, a spring 11 is situated between the base body 1 and the flap 2 and is held by an adjusting screw 12. The adjusting screw 12 therefore passes through the spring 11, which is designed as a helical spring, along its length, such that it passes through a hole in the flap and is screwed into the base body 1. The head of the screw is then in contact with the top side of the flap 2. The spring 11 forces the base body 1 and the flap 2 slightly apart, so that in the basic position, the two electric contacts 9, 10 are a distance apart from one another, their distance being determined by the position of the adjusting screw 12. The spacing of the contacts and the response sensitivity of the button can thus be varied by screwing the adjusting screw 12 in or out. The prestress on the spring 11 determines the force by which the flap 2 must be pressed downward in order for the two electric contacts 9, 10 to come in contact and close a circuit. To replace the batteries, the adjusting screw 12 may be removed completely so that the flap 2 can be folded back.

The two contacts 9, 10 generate an impact sound when they come in contact with each other, which may also be used as a signal for the trainer to dispense a reward to the dog.

The device may thus be used without first having to be turned on by means of the switch 7. It may be possible to utilize the impact sound alone when the dog has become accustomed to the device and a weak impact sound is sufficient to encourage the dog to operate the button.

A resonance chamber 13, into which a buzzer 14 attached to the base body protrudes, is provided on the underside of the flap 2. The base body 1 also contains all the electric components, which are not shown in greater detail here and are necessary for operation of the buzzer. Electrical engineers will be familiar with the circuits required for this, so they need not be described in greater detail here.

In addition, there is a metal plate 15 on the flap 2. This is used for the case when the device is to be worn beneath an item of clothing. To provide an activation surface for the dog, an operating button with a magnet at the level of the metal plate is attached to the outside of the clothing, so that the operating button is held magnetically there.

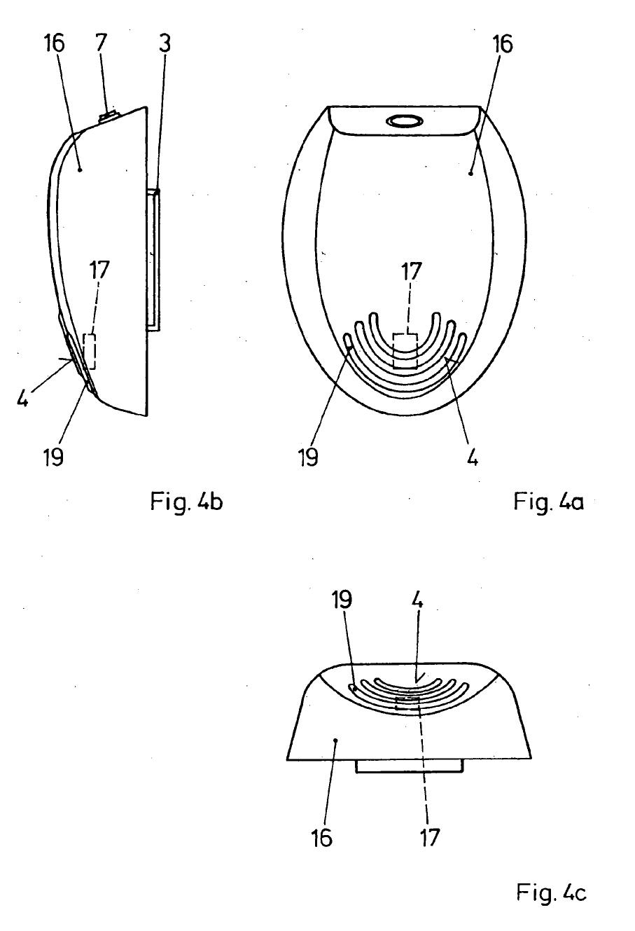

FIGS. 4a, 4b and 4c illustrate one embodiment of the device in which the base body and flap are embodied as a uniform housing and a proximity sensor 17, shown with a dash-dot line, is situated in this housing 16 beneath the activation surface 4, assuming the functions of the two electric contacts according to the first embodiment. When the dog's muzzle approaches the activation surface 4, the proximity sensor 17 responds and a circuit for the buzzer 14 is closed. The response sensitivity is set electronically in this case.

The circuit for operating the buzzer 14 may be designed in both embodiments, so that the buzzing sound persists as long as the contacts are closed and/or the dog's muzzle is on the activation surface 4. However, a timer circuit may also be provided, interrupting the buzzing sound after a certain brief period of time, regardless of whether the dog's muzzle is still on the activation surface 4.

To familiarize the dog with the device and/or to encourage the dog to use it, the activation surface 4 may be covered with an edible paste. It is therefore provided with grooves 18 (see also FIG. 2a) or webs 19 or otherwise provided with recesses and/or elevations.

### LIST OF REFERENCE NUMERALS

1 Base body

2 Flap

3 Strap

4 Activation surface

5 Surface normal

6 Hinge

7 On/off switch

8 Battery compartment

9 First electric contact

10 Second electric contact

11 Spring

12 Adjusting screw

13 Resonance chamber

14 Buzzer

15 Metal plate

16 Housing

17 Proximity sensor

18 Grooves

19 Webs

1-10. (canceled)

11. A method for training a dog, comprising the steps of:
wearing a device on a side of a body of a trainer of the dog at a height of a head of the dog;
activating a button on the device by a muzzle of the dog to generate a noise; and
giving a reward to the dog by the trainer following the step of activating the button, at least in an initial phase of training.

12. The method of claim 11, wherein the noise is a buzzing sound.

13. The method of claim 11, wherein the reward is a chewable reward.

14. The method of claim 11, wherein the device is worn such that the device is situated above the head of the dog and such that the dog must extend its head laterally upward for activation of the button.

15. A noise-generating device for training a dog, comprising:
a housing with a noise-generating element and a button for operation of the noise-generating element; and
an attachment device provided on a back side of the housing, wherein the attachment device is coupleable to a body of a trainer;
wherein an activation surface for the button is provided on a front side of the housing and wherein a surface normal of the activation surface, when worn on the body of the trainer, is inclined obliquely downward and laterally away from the body of the trainer.

16. The device according to claim 15, wherein the housing includes a base body and a flap attached to the base body by a hinge, wherein the attachment device is provided on the back side of the base body and the activation surface is provided on a front side of the flap.

17. The device according to claim 16, wherein the button includes a spring prestressed between the base body and the flap and electric contacts formed on the flap and on the base body, wherein the electric contacts come in contact as a result of a movement of the flap against a force of the spring moving in a direction of the base body to close a circuit for the noise-generating element.

18. The device according to claim 16, wherein the noise-generating element is disposed in the base body and wherein a resonance chamber is formed in a back side of the flap facing the base body.

19. The device according to claim 15, wherein the button is a proximity sensor which is disposed beneath the activation surface.

20. The device according to claim 15, wherein recesses and/or elevations are provided in the activation surface.
